(19) United States
(12) Patent Application Publication
(10) Pub. No.: US 2016/0349726 A1
(43) Pub. Date: Dec. 1, 2016

(54) APPARATUS AND METHOD FOR VARIABLE DATA COLLECTION OF INTELLIGENT LOOP PERFORMANCE MONITORING SYSTEM IN BANDWIDTH-CONSTRAINED DCS

(71) Applicant: Honeywell International, Inc., Morristown, NJ (US)

(72) Inventors: Ranganathan Srinivasan, Bangalore (IN); Gobinath Pandurangan, Bangalore (IN); Perry Nordh, Calgary (CA)

(21) Appl. No.: 14/723,022

(22) Filed: May 27, 2015

(51) Int. Cl. G05B 19/048

(52) U.S. Cl. CPC G05B 19/048; G05B 2219/23463

(57) ABSTRACT

A method includes performing an initial analysis using first data collected at a first collection frequency from a data source of a processing facility. The method also includes identifying at least one control loop in the processing facility having a potential problem based on the initial analysis and selecting a root cause analysis to execute in order to determine a root cause of the potential problem. The method further includes generating a schedule file and a loop identifier file associated with a request to collect, from the data source, second data for the at least one control loop at a higher second collection frequency for a specified duration. The request specifies the specified duration, the second collection frequency, and the at least one specified control loop. In addition, the method includes transmitting the schedule file to a data collector and the loop identifier file to a database.

### TECHNICAL FIELD

This disclosure is generally directed to loop performance monitoring systems. More specifically, this disclosure is directed to an apparatus and method for variable data collection of an intelligent loop performance monitoring system in a bandwidth-constrained distributed control system (DCS).

### BACKGROUND

Industrial process control and automation systems are often used to automate large and complex industrial processes. Many industrial facilities need a loop performance monitoring tool to sustain the benefits of automation when using a distributed control system (DCS). However, conventional loop performance monitoring tools often require high fidelity data to provide meaningful diagnoses that could improve operational efficiency. This becomes problematic when fast control loops, such as pressure control loops and flow control loops, are used. While Object Linking and Embedding (OLE) for Process Control (OPC) can be used to collect high frequency data for several hundred loops in a bandwidth-constrained DCS, this often negatively affects other applications that use OPC.

### SUMMARY

This disclosure provides an apparatus and method for variable data collection of an intelligent loop performance monitoring system in a bandwidth-constrained distributed control system (DCS).

In a first embodiment, a method includes collecting, at a first collection frequency, first data from a data source of a processing facility. The method also includes receiving a request to change a data collection frequency for at least one specified control loop of the processing facility to a higher second collection frequency for a specified duration. The request specifies the specified duration, the second collection frequency, and the at least one specified control loop. The method further includes collecting, at the second collection frequency, second data from the data source for the specified duration.

In a second embodiment, a method includes performing an initial analysis using first data collected at a first collection frequency from a data source of a processing facility. The method also includes identifying at least one control loop in the processing facility having a potential problem based on the initial analysis and selecting a root cause analysis to execute in order to determine a root cause of the potential problem. The method further includes generating a schedule file and a loop identifier file associated with a request to collect, from the data source, second data for the at least one control loop at a higher second collection frequency for a specified duration. The request specifies the specified duration, the second collection frequency, and the at least one specified control loop. In addition, the method includes transmitting the schedule file to a data collector and the loop identifier file to a database.

In a third embodiment, a system includes at least one interface configured to communicate with a data collector and a database. The system also includes at least one processing device configured to perform an initial analysis using first data collected by the data collector at a first collection frequency from a data source of a processing facility. The at least one processing device is also configured to identify at least one control loop in the processing facility having a potential problem based on the initial analysis and select a root cause analysis to execute in order to determine a root cause of the potential problem. The at least one processing device is further configured to generate a schedule file and a loop identifier file associated with a request to collect, from the data source, second data for the at least one control loop at a higher second collection frequency for a specified duration. The request specifies the specified duration, the second collection frequency, and the at least one specified control loop. In addition, the at least one processing device is configured to initiate transmission of the schedule file to the data collector and the loop identifier file to the database.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example industrial process control and automation system according to this disclosure;

FIG. 2 illustrates an example intelligent loop performance monitoring system according to this disclosure;

FIG. 3 illustrates an example system architecture and an example data flow of a system having a variable data collector according to this disclosure;

FIG. 4 illustrates an example variable data collection process according to this disclosure; and

FIG. 5 illustrates an example device supporting variable data collection of an intelligent loop performance monitoring system according to this disclosure.

### DETAILED DESCRIPTION

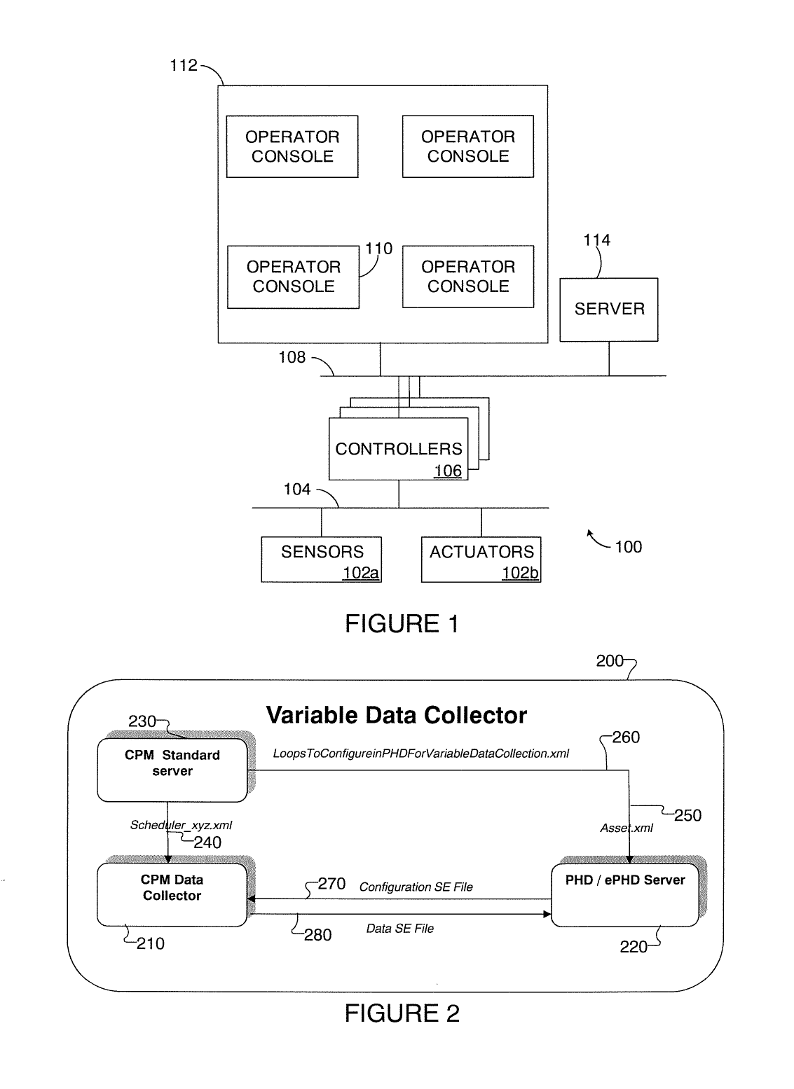

FIGS. 1 through 5, discussed below, and the various examples used to describe the principles of the present invention in this patent document are by way of illustration only and should not be construed in any way to limit the scope of the invention. Those skilled in the art will understand that the principles of the present invention may be implemented in any suitable manner and in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control over components in one or multiple industrial plants. Each plant represents one or more processing facilities (or one or more portions thereof). Example processing facilities include manufacturing plants for producing at least one product or other material, chemical plants, crude oil refineries, ore processing plants, and paper or pulp manufacturing and processing plants. In general, each plant may implement one or more industrial processes and can individually or collectively be referred to as a process system. A process system generally represents any system or portion thereof configured to process one or more products or other materials in some manner.

In FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system. Example actuators 102b include heaters, motors, catalytic crackers, or valves.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network, electrical signal network (such as a HART or FOUNDATION FIELDBUS network), pneumatic control signal network, or any other or additional type(s) of network(s).

Various controllers 106 are coupled directly or indirectly to the network 104. The controllers 106 can be used in the system 100 to perform various functions. For example, a first set of controllers 106 may use measurements from one or more sensors 102a to control the operation of one or more actuators 102b. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent multivariable controllers, such as Robust Multivariable Predictive Control Technology (RMPCT) controllers or other type of controllers implementing model predictive control (MPC) or other advanced predictive control (APC). At least some of the controllers 106 can form a distributed control system (DCS).

Operator access to and interaction with the controllers 106 and other components of the system 100 can occur via various operator consoles 110. Each operator console 110 could be used to provide information to an operator and receive information from an operator. For example, each operator console 110 could provide information identifying a current state of an industrial process to the operator, including warnings, alarms, or other states associated with the industrial process. Each operator console 110 could also receive information affecting how the industrial process is controlled, such as by receiving setpoints for process variables controlled by the controllers 106 or by receiving other information that alters or affects how the controllers 106 control the industrial process. Multiple operator consoles 110 can be grouped together and used in one or more control rooms 112. Each operator console 110 includes any suitable structure for displaying information to and interacting with an operator. For example, each operator console 110 could represent a desktop, laptop, or other computing device.

At least one server 114 can be used to perform various operations in the system 100. For example, the server 114 could execute a loop performance monitoring tool, which analyzes control loops within an industrial plant and provides diagnoses of loops that have problems. However, these diagnoses often involve an analysis of high fidelity data, which may require that high frequency data be collected from the plant in order to analyze the health of various control loops in the plant. In order to obtain this high frequency data, a non-intelligent loop performance monitoring tool (such as one executed on a controller or operator station) is conventionally used to collect data from the sensors 102a, actuators 102b, or other components at a high frequency (such as once per second) over a prolonged period of time (such as all day, every day). As such, the data collection process for the loop performance monitoring tool could monopolize bandwidth of the plant in order to collect the high frequency data.

One solution to reduce bandwidth consumption is to analyze only critical control loops, where the data collection process limits bandwidth consumption by obtaining high frequency data only for the critical loops. However, this would result in the failure to observe the health of loops that are not considered “critical.” Another solution to reduce bandwidth consumption is to cyclically analyze all loops over a period of time but analyze only a few loops at any given time, where the data collection process limits bandwidth consumption by obtaining high frequency data only for a few control loops. However, this means that measurements of degradation within a control loop would not be captured immediately. In both solutions, the data collection process is not intelligent enough to identify the characteristics of data needed for analyzing the health of various loops in a plant. That is, the data collection process cannot determine whether high frequency data is needed or whether low frequency data is sufficient for analyzing the health of a control loop. Also, the data collection process cannot determine a duration of time in which data collection is needed for analyzing the health of a control loop.

This disclosure provides a technique that overcomes bandwidth issues without compromising diagnoses provided by a loop monitoring tool. As described in more detail below, the system 100 implements an intelligent loop performance monitoring system, which can be used (among other places) in bandwidth-constrained DCS systems. The intelligent loop performance monitoring system implements a variable frequency collection methodology on problematic control loops to collect high frequency data, where the collection duration is intelligently estimated based on the loop type and system bandwidth constraints.

The intelligent loop performance monitoring system can identify problematic control loops using coarse data (collections of low frequency data), even though diagnosis of a problem is not possible using the coarse data. Once a problem is detected, the intelligent loop performance monitoring system performs a detailed diagnosis on only those control loops that are identified as problematic using high frequency data for a minimal duration of time. This allows high frequency data to be collected only on an as-needed basis (after a loop is flagged as being possibly problematic using the coarse low frequency data). Moreover, a smart diagnosis algorithm can auto-classify the low frequency data and high frequency data and run a diagnosis when appropriate to identify a root cause of a problem.

The intelligent loop performance monitoring system can be implemented in any suitable manner within the system 100 or other system. For example, the intelligent loop performance monitoring system could be implemented using at least one data source, at least one server, and at least one variable data collector, where the variable data collector(s) can collect data from the data source(s) and provide the data to the server for analysis. The frequency of data collection from a data source for a problematic control loop is increased such that a diagnosis can be made using high fidelity data, and the duration of high frequency collection can be defined based on various factors (such as the loop type and sampling requirements for an algorithm that identifies mechanical and loop tuning issues). The high frequency portion of collected data can be identified automatically and one or more diagnosis routines can be invoked only using the high frequency portion of the data. After the diagnosis of a problem, the loop collection frequency can be changed back to a lower rate adequate to identify potential problems and flag issues for detailed diagnosis again. The data source(s), server(s), and variable data collector(s) could be implemented using any suitable components of the system 100. For instance, data sources could include the sensors 102a and actuators 102b, and the servers and data collectors could be implemented using computing devices (like controllers 106, operator consoles 110, or servers 114).

Although FIG. 1 illustrates one example of an industrial process control and automation system 100, various changes may be made to FIG. 1. For example, industrial control and automation systems come in a wide variety of configurations. The system 100 shown in FIG. 1 is meant to illustrate one example operational environment in which intelligent loop performance monitoring can be used, although this functionality could be used in any other suitable system.

FIG. 2 illustrates an example intelligent loop performance monitoring system 200 according to this disclosure. Although certain details will be provided with reference to the components of the system 200, it should be understood that other embodiments may include more, less, or different components.

The system 200 here includes a data collector 210, a database 220, and a server 230. The data collector 210 communicates with the database 220 to exchange information and with the server 230 to receive information. The data collector 210 collects data associated with one or more control loops, such as by collecting data from one or more sensors or actuators. The data collector 210 can also collect data for control loops at different rates, such as at a lower frequency until a potential problem with a control loop is identified. For this reason, the data collector 210 can be said to represent a control performance monitor (CPM) variable data collector. The “variable” feature enables scheduled collection of fast frequency data and low frequency data as needed. For example, the data collector 210 can collect measurements at a frequency of once per second for a period of two hours during a scheduled time. The data collector 210 includes any suitable structure for collecting data at different rates for specified durations.

The database 220 stores data collected by the data collector 210 and provides configuration data to the data collector 210. The configuration data can control, among other things, the rate at which the data collector 210 collects data. In some embodiments, the data collector 210 uses a cloud-based infrastructure to exchange data with the database 220. The database 220 includes any suitable structure for storing and retrieving data, such as a plant historian database (PHD) or enhanced PHD (ePHD) server.

The server 230 can control the data collector 210 using information sent to directly to the data collector 210 to indirectly via the database 220. The server 230 can also analyze the collected data to identify potential problems in an industrial plant and to identify potential root causes of the problems. The server 230 denotes any suitable computing device, such as a CPM standard server.

As noted above, the server 230 can analyze coarse (lower frequency) data collected by the data collector 210 until a potential problem is identified and then increase the data collection rate so that high fidelity (high frequency) data can be used to identify an actual problem and its potential root causes. To accomplish this, the server 230 generates and sends a schedule 240 to configure variable data collection in the data collector 210 in response to determining that a control loop has a potential problem. The server 230 also generates and sends asset data 250 and loop identification data 260 to configure variable data collection in the database 220. The database 220 generates and sends a configuration data file 270 to configure variable data collection in the data collector 210, and the data collector 210 reconfigures itself based on the schedule 240 and the configuration data file 270. For example, the data collector 210 can retrieve data from sensors and actuators in a plant, adapt a frequency of data collection for a set of loops identified in the loop identification data 260 according to the schedule 240, and send collected data in a data file 280 to the database 220 in a format specified in the configuration data file 270.

In this example, XML files can be used to exchange data between the various components in the system 200. For example, the server 230 sends a Scheduler_xyz.xml file as the schedule 240, an Asset.xml file as the asset data 250, and a LoopsToConfigureinPHDForVariableDataCollection.xml file as the loop identification data 260. The server 220 sends a configuration SE file as the configuration data file 270, and the data collector 210 sends a data SE file as the collected data file 280.

Although FIG. 2 illustrates one example of an intelligent loop performance monitoring system 200, various changes may be made to FIG. 2. For example, the system 200 could include any number of data collectors, databases and servers. Also, the functional division shown in FIG. 2 is for illustration only. Various components in FIG. 2 could be combined, further subdivided, or omitted and additional components could be added according to particular needs.

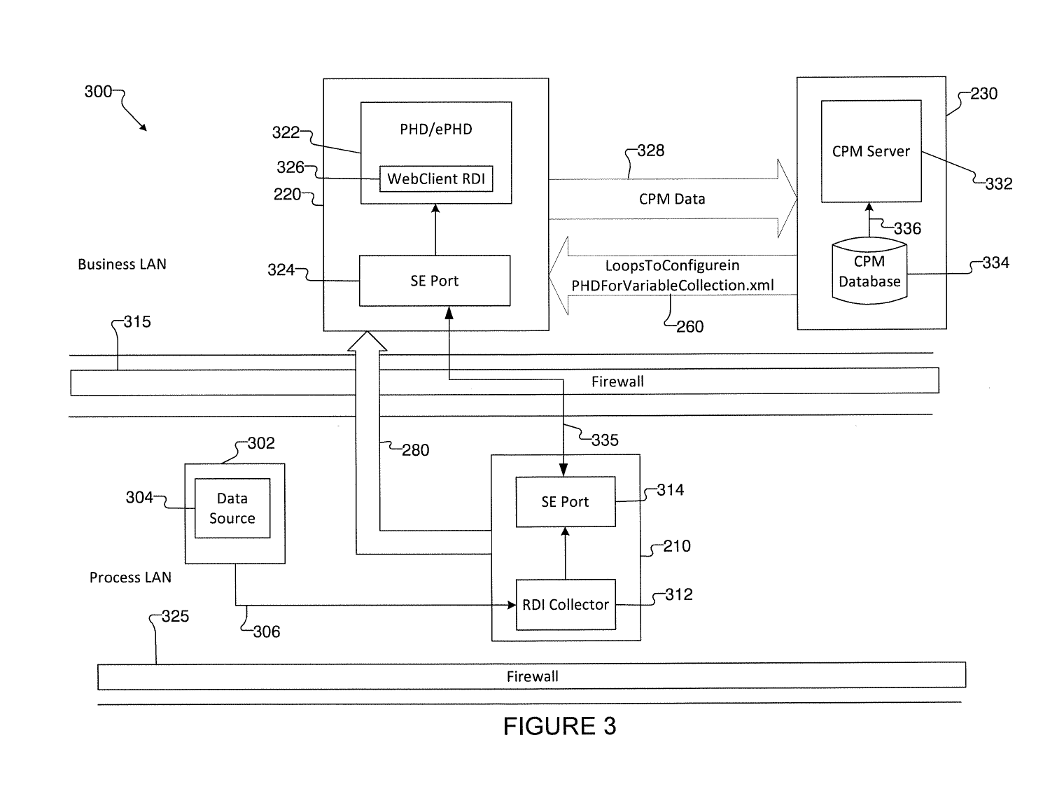

FIG. 3 illustrates an example system architecture and an example data flow of a system 300 having a variable data collector according to this disclosure. The system 300 could, for example, include the various components 210-230 from FIG. 2. Although certain details will be provided with reference to the components of the system 300, it should be understood that other embodiments may include more, less, or different components.

As shown in FIG. 3, the system 300 includes a processing facility 302, which can include one or more data sources 304. Example data sources 304 include sensors 102a, actuators 102b, or a DCS. The processing facility 302 includes at least one communication interface 306, such as a remote data interface (RDI). The communication interface 306 can connect to and communicate with other components of the system 300.

The system 300 also includes a business local area network (LAN) and a process LAN separated by a firewall 315. The process LAN is isolated between two firewalls 315 and 325. The processing facility 302 and the data collector 210 form part of a process network. The database 220 and the server 230 form part of the business LAN.

The data collector 210 here includes an RDI collector 312 and an SE port 314. The data collector 210 retrieves data (such as sensor measurements and actuator modes) from the processing facility 302. For example, the RDI collector 312 can connect to the communication interface 306 and collect data from the data source(s) 304. The RDI collector 312 also performs variable frequency collection, such as by collecting data at a low collection frequency, adaptively changing the frequency to collect data at a high collection frequency for a specific duration, and then returning to collecting data at the low collection frequency.

As a particular example, during normal operation, the RDI collector 312 can collect data from the data source 304 at a nominal collection frequency (such as every 30 seconds or some other low collection frequency) and send the collected data to the database 220 for storage in a plant historian database 322. The RDI collector 312 can adjust the collection frequency based on input received from the server 230. For instance, the RDI collector 312 can receive information from both the server 230 and the database 220, where the information forms a request. The request instructs the RDI collector 312 to adjust its collection frequency to a specified collection frequency for a specified duration for one or more specified control loops, and the RDI collector 312 selects when to execute the request. The data collector 210 is not limited to collecting data from all control loops at the same collection frequency. Rather, the RDI collector 312 enables the data collector 210 to collect data from different control loops at different collection frequencies.

In some embodiments, to form a request for the data collector 210, the RDI collector 312 copies a schedule file 240 generated by a CPM server 332 and copies a configuration data file 270 from a PHD/ePHD server 322 of the database 220. The RDI collector 312 imports these two files that form the request into a CPM collector configurator tool described below. The RDI collector 312 selects and provides a start time, an end time, and a collection frequency for the data collector 210 to execute the request. The RDI collector 312 performs load management of multiple requests for data collection according to a bandwidth limitation in order to meet the multiple requests without exceeding the bandwidth limitation. That is, the RDI collector 312 selects the start time and end time based on the load management of the multiple previously-received requests for data collection at a higher than normal frequency. In some embodiments, the set of high frequency data collected to meet a request can be collected only between the start time and the end time. After the end time, the RDI collector 312 can automatically change the collection frequency back to a low collection frequency.

The RDI collector 312 provides the collected data as at least one data file 280 to the PHD/ePHD 322 for storage. In some embodiments, the data collector 210 generates a data file 280 by encrypting data that the RDI collector 312 retrieved from the data source 304. In some embodiments, the data collector 210 uses the SE port 314 to automatically transport the data file 280 to an SE port 324 of the database 220.

The SE port 314 represents a communication interface within the data collector 210 and performs bidirectional communication with the SE port 324 of the database 220 through a data communication channel 335. The data communication channel 335 transports the files 270-280 to and from the data collector 210 through the firewall 315.

The database 220 includes the SE port 324 and the PHD/ePHD server 322, which includes a WebClient RDI 326. The database 220 receives the data file 280 from the data collector 210 and stores the data in the plant historian database using the PHD/ePHD server 322. The PHD/ePHD server 322 provides CPM data 328 to the server 230, enabling the CPM server 332 to perform analyses on the CPM data 328. Specifically, the CPM server 332 is configured to perform an initial analysis on low frequency data or a root cause analysis on high frequency data. The database 220 copies loop identification data 260 from the server 230 that generated it. The PHD/ePHD server 322 generates a file called CPM.xml encrypted into a configuration data file 270, which the data collector 210 reads and copies.

In some embodiments, the WebClient RDI 326 is created by the loop identification data 260 and generates the CPM.xml file. The configuration data file 270 includes a PHD tag number, a scan frequency, a data type, and other parameters. In some embodiments, the WebClient RDI 326 moves the configuration data file 270 to the data collector 210 or is used by the RDI collector 312 to collect data.

The server 230 includes the CPM server 332 that performs an initial analysis on low frequency CPM data 328 to identify whether there is a problem in any of the multiple loops within the processing facility 302. When the initial analysis indicates that a problem exists within one or more of the multiple loops, the CPM server 332 initiates a process to determine the root cause of the problem. The CPM server 332 includes a CPM configurator tool that configures a variable data collection process in order to determine the root cause. For example, the CPM server 332 generates a loop identification data 260 and a schedule file 240. In some embodiments, the CPM server 332 transmits the loop identification data 260 to the PHD/ePHD server 322 and transmits the schedule file 240 to the RDI collector 312. The loop identification data 260 specifies problematic control loops for which a root cause analysis will be performed. Also, the loop identification data 260 configures the PHD/ePHD server 322 to receive and store high frequency data for those specified problematic control loops. The loop identification data 260 configures tags into the database 220 and is used to create tags in the PHD/ePHD. The CPM server 332 uses the tags to extract high frequency data collected in response to a request generated by the CPM server 332 from other data (low frequency data) received from the data source 304. The loop identification data 260 is configured to create the WebClient RDI 326 in the PHD/ePHD server 322. For each problematic control loop, the schedule file 240 specifies a duration of time that high frequency data collection is needed for analyzing the root cause of a problem in the loop. The schedule file 240 identifies the control loops whose data is to be collected using the data collector, and in some embodiments updates a fast collection frequency or updates disabled fast data collection for certain tags.

The server 230 also includes a CPM database 334 that provides data 336 to the CPM server 332. For example, the data 336 can include association data associating a type of control loop with a list of root cause analyses that can be performed for that type of control loop. The data 336 can also include association data associating each type of root cause analysis with characteristics of data needed to execute the root cause analysis. The characteristics of data can include collection frequency and collection duration.

As a specific example, when an initial analysis indicates a control loop has a potential problem, the CPM server 332 can select at least one root cause analysis, such as one that determines whether a valve in a control loop suffers from stiction. A stiction root cause analysis may require data characterized by a collection duration of four hours and a collection frequency of one second. Accordingly, the CPM server 332 generates a schedule file 240 configuring the system 300 for data to be collected from the control loop of the processing facility 302 at a one second collection frequency for four hours.

The CPM server 332 can provide the CPM configurator tool in an online mode. In some embodiments, the CPM configurator tool is a tab of a user interface that receives user inputs to configure variable data collection and allows the user to save a user-selected variable data collection configuration. The CPM configurator tool is applicable for control loops associated with a hierarchy. Once the user has saved a user-inputted variable data collection configuration, the CPM server 332 generates a schedule file 240 to configure variable data collection in the data collector 210.

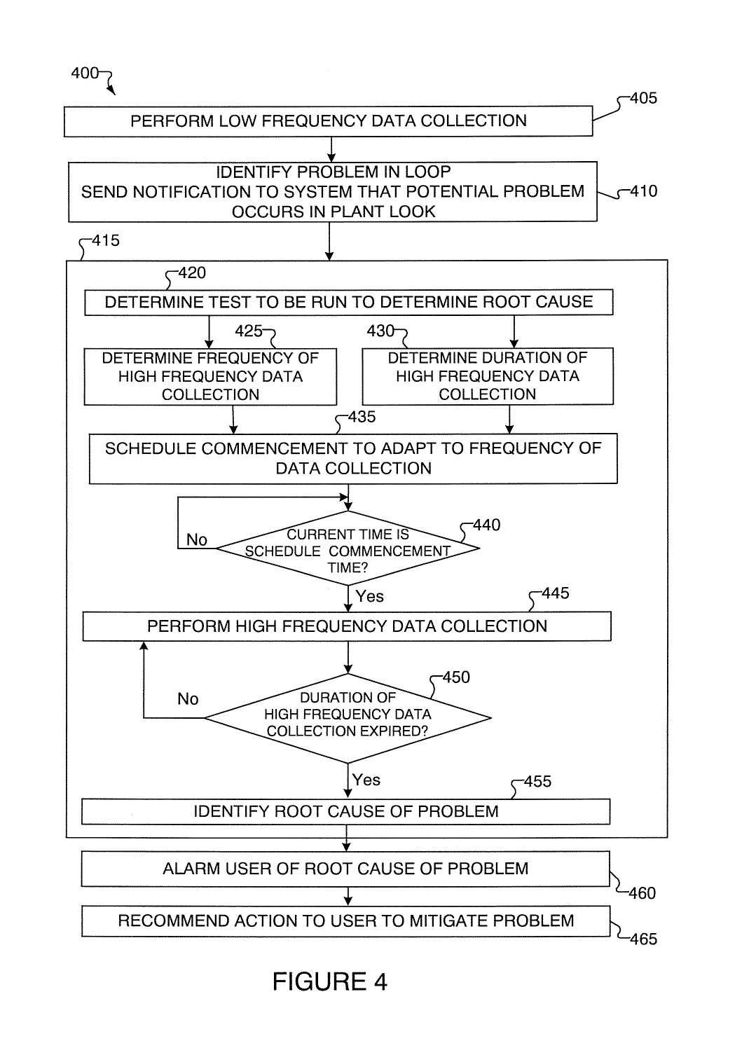

FIG. 4 illustrates an example variable data collection process 400 according to this disclosure. The process 400 can be implemented using any suitable devices and in any suitable systems. For ease of explanation, the process 400 is described with respect to the system 100 of FIG. 1 and the intelligent loop performance monitoring system 200 of FIG. 2.

The process 400 generally includes three stages. In a first stage, low frequency data collection occurs at step 405. This could include, for example, the data collector 210 collecting data about one or more control loops at a lower frequency. The interval of the low collection frequency depends on the application. An example interval would be one minute. A potential problem in a loop is identified and a notification is sent regarding the potential problem at step 410. This could include, for example, the server 230 performing an initial analysis using the low frequency data to identify the potential problem. In response to determining that the low frequency data indicates a problem in a loop, the server 230 can send a notification to the data collector 210 that a potential problem is occurring in a plant loop. This notification need not be provided to an operator console 110 and need not result in generation of an alarm. Rather, this notification could simply prepare the system to perform a root cause analysis.

In the second stage (collectively step 415), at least one root cause of the potential problem is identified. For example, one or more tests to be performed to determine the root cause could be selected at step 420. This could include, for example, the server 230 using the collected data to identify which control loop or loops have potential problems and the type of each problematic loop. This could also include the server 230 accessing the database 220 to identify one or more root cause analyses associated with each type of loop. This could further include the server 230 selecting a root cause analysis to perform based on the type of loop.

The frequency of data to be collected is identified at step 425, and the duration of high frequency data collection is identified at step 430. This could include, for example, the server 230 accessing the database 220 to determine a collection frequency and duration associated with a selected root cause analysis. In some embodiments, the collection frequency and duration are associated with each other and are together associated with a specific type of root cause analysis.

A time for adapting the data collection to the higher frequency is scheduled at step 435, and a check is made whether that time has arrived at step 440. This could include, for example, the server 230 providing the schedule 240 to the data collector 210 and the asset data 250 and loop identification data 260 to the database 220. Step 440 can continue until the scheduled time for higher frequency data collection arrives. High frequency data collection then occurs at step 445, and a check is made whether the duration for high frequency data collection has expired at step 450. During this time, the data collector 210 collects data at the specified higher rate for the specified duration. This allows higher fidelity data to be collected for analysis. When the duration of high frequency data collection expires, the system can automatically change the collection frequency back to a lower frequency.

After the duration expires at step 450, at least one potential root cause of an identified control loop problem is identified at step 455. This could include, for example, the server 230 analyzing the high frequency data using one or more root cause analyses to identify a possible cause for a loop problem. The analyses can omit the low frequency data if desired.

The third stage of the process involves using the root cause in some way. For example, an alarm can be generated identifying the problem and its cause at step 460, and a recommended action to mitigate the problem can be provided to a user at step 465.

Although FIG. 4 illustrates one example of a variable data collection process 400, various changes may be made to FIG. 4. For example, while shown as a series of steps, various steps in FIG. 4 could overlap, occur in parallel, occur in a different order, or occur any number of times.

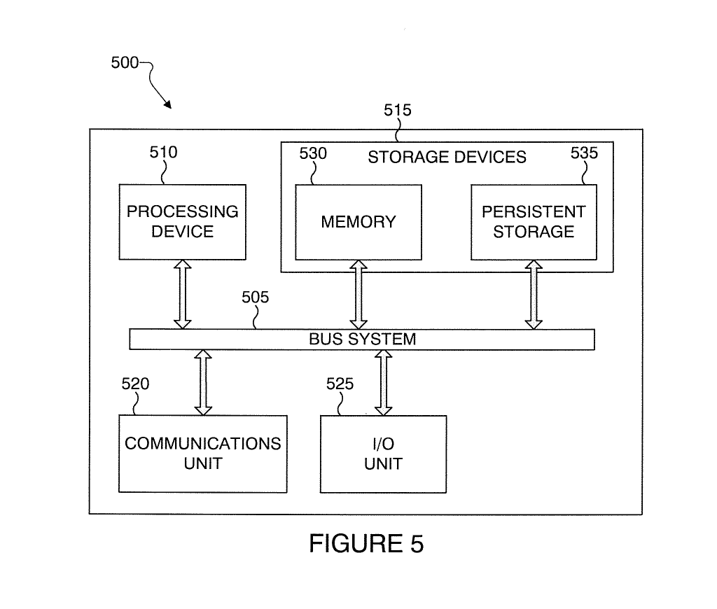

FIG. 5 illustrates an example device 500 supporting variable data collection of an intelligent loop performance monitoring system according to this disclosure. The device 500 could, for example, represent the server 230 or other computing device supporting intelligent loop performance monitoring.

As shown in FIG. 5, the device 500 includes a bus system 505, which supports communication between at least one processing device 510, at least one storage device 515, at least one communications unit 520, and at least one input/output (I/O) unit 525.

The processing device 510 executes instructions that may be loaded into a memory 530. The processing device 510 may include any suitable number(s) and type(s) of processors or other devices in any suitable arrangement. Example types of processing devices 510 include microprocessors, microcontrollers, digital signal processors, field programmable gate arrays, application specific integrated circuits, and discreet circuitry.

The memory 530 and a persistent storage 535 are examples of storage devices 515, which represent any structure(s) capable of storing and facilitating retrieval of information (such as data, program code, and/or other suitable information on a temporary or permanent basis). The memory 530 may represent a random access memory or any other suitable volatile or non-volatile storage device(s). The persistent storage 535 may contain one or more components or devices supporting longer-term storage of data, such as a ready only memory, hard drive, Flash memory, or optical disc.

The communications unit 520 supports communications with other systems or devices. For example, the communications unit 520 could include a network interface card or a wireless transceiver facilitating communications over the network 105. The communications unit 520 may support communications through any suitable physical or wireless communication link(s).

The I/O unit 525 allows for input and output of data. For example, the I/O unit 525 may provide a connection for user input through a keyboard, mouse, keypad, touchscreen, or other suitable input device. The I/O unit 525 may also send output to a display, printer, or other suitable output device.

Although FIG. 5 illustrates one example of a device 500 supporting variable data collection of an intelligent loop performance monitoring system, various changes may be made to FIG. 5. For example, computing devices come in a wide variety of configurations. The device 500 shown in FIG. 5 is meant to illustrate one example type of computing device and does not limit this disclosure to a particular type of computing device.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed:

1. A method comprising:
collecting, at a first collection frequency, first data from a data source of a processing facility;
receiving a request to change a data collection frequency for at least one specified control loop of the processing facility to a higher second collection frequency for a specified duration, the request specifying the specified duration, the second collection frequency, and the at least one specified control loop; and
collecting, at the second collection frequency, second data from the data source for the specified duration.

2. The method of claim 1, wherein the request comprises a configuration file from a database, the configuration file identifying the second collection frequency and the specified duration.

3. The method of claim 1, wherein the request comprises a schedule file from a server, the schedule file identifying the at least one control loop.

4. The method of claim 1, further comprising:
performing load management of multiple requests for data collection according to a bandwidth limitation in order to meet the multiple requests without exceeding the bandwidth limitation.

5. The method of claim 1, further comprising:
in response to receiving the request, selecting a start time and an end time; and
collecting the second data at the higher collection frequency only between the start time and the end time.

6. The method of claim 5, further comprising:
after collecting the second data, automatically changing the data collection frequency to the first collection frequency.

7. The method of claim 1, further comprising:
automatically transmitting to a database at least one of: the first data and the second data.

8. A method comprising:
performing an initial analysis using first data collected at a first collection frequency from a data source of a processing facility;
identifying at least one control loop in the processing facility having a potential problem based on the initial analysis;
selecting a root cause analysis to execute in order to determine a root cause of the potential problem;
generating a schedule file and a loop identifier file associated with a request to collect, from the data source, second data for the at least one control loop at a higher second collection frequency for a specified duration, the request specifying the specified duration, the second collection frequency, and the at least one specified control loop; and
transmitting the schedule file to a data collector and the loop identifier file to a database.

9. The method of claim 8, wherein the schedule file identifies the at least one control loop.

10. The method of claim 8, wherein the loop identifier file is configured to create a webclient that generates a configuration file forming part of the request.

11. The method of claim 10, wherein the configuration file identifies the second collection frequency and the specified duration.

12. The method of claim 8, further comprising:
extracting the second data from other data received from the data source.

13. The method of claim 8, further comprising:
receiving the second data from the data collector; and
performing the root cause analysis using the second data.

14. The method of claim 13, further comprising:
providing, to a user interface, an alarm indicating the root cause based on the root cause analysis.

15. The method of claim 13, further comprising:
providing, to a user interface, a recommended action to mitigate the potential problem.

16. A system comprising:
at least one interface configured to communicate with a data collector and a database; and
at least one processing device configured to:
perform an initial analysis using first data collected by the data collector at a first collection frequency from a data source of a processing facility;
identify at least one control loop in the processing facility having a potential problem based on the initial analysis;
select a root cause analysis to execute in order to determine a root cause of the potential problem;
generate a schedule file and a loop identifier file associated with a request to collect, from the data source, second data for the at least one control loop at a higher second collection frequency for a specified duration, the request specifying the specified duration, the second collection frequency, and the at least one specified control loop; and
initiate transmission of the schedule file to the data collector and the loop identifier file to the database.

17. The system of claim 16, wherein:
the schedule file identifies the at least one control loop; and
the loop identifier file is configured to create a webclient that generates a configuration file forming part of the request, the configuration file identifying the second collection frequency and the specified duration.

18. The system of claim 16, wherein the at least one processing device is further configured to:
receive the second data from the data collector; and
perform the root cause analysis using the second data.

19. The system of claim 16, wherein the at least one processing device is further configured to provide, to a user interface, an alarm indicating the root cause based on the root cause analysis.

20. The system of claim 16, wherein the at least one processing device is further configured to provide, to a user interface, a recommended action to mitigate the potential problem.
